(19) United States
(12) Patent Application Publication
(10) Pub. No.: US 2017/0011866 A1
(43) Pub. Date: Jan. 12, 2017

(54) DOOR LOCKING DEVICE FOR HOUSEHOLD APPLIANCES

(71) Applicant: ELETTROTECNICA ROLD S.R.L., Nerviano (IT)

(72) Inventor: Stefano ROCCHITELLI, Pogliano Milanese (IT)

(73) Assignee: ELETTROTECNICA ROLD S.R.L., Nerviano (IT)

(21) Appl. No.: 15/115,438

(22) PCT Filed: Feb. 2, 2015
(86) PCT No.: PCT/IB2015/050774

§ 371 Date: Jul. 29, 2016

(30) Foreign Application Priority Data
Feb. 3, 2014 (IT) MI2014A000152

(51) Int. Cl. H01H 9/22; E05B 47/00; D06F 39/14

(52) U.S. Cl. CPC H01H 9/226; D06F 39/14; E05B 47/0001; H01H 2300/024; H01H 2231/012; E05B 2047/0068; E05B 2047/0048

(57) ABSTRACT

The present invention relates to a door locking device for household appliances. The device according to the present invention allows to detect a door closing or opening condition, to actuate, only with the door closed, an electromagnetic actuator that triggers door locking means and a respective switch, and finally to detect the door locking condition. The operation of the door lock required by current safety standards is obtained here by means of an architecture of the door lock which allows to simplify the architecture of the door lock itself, in particular by reducing the connecting contacts with the household appliance to only two.

### FIELD OF THE INVENTION

The present invention relates to door locking device for household appliances. So-called locking devices for locking the door of a household appliance, typically a washing machine, which comprise a device for detecting a closing condition of a household appliance door, a device for locking and possibly unlocking the household appliance door and a device for detecting the locking condition of such a door, are known and commonly used in the field of household appliances.

The device for detecting the closing condition determines whether the household appliance door is closed.

The closing condition of the door causes the closing of a switch, so that the electronics of the machine can detect that the door is actually in the closing position.

The closing condition of the door is a precondition for the door to be locked.

The locking device of the household appliance door can be actuated in order to lock the closed door if the door is in the closing condition, and thus take it to a condition in which the door cannot be opened.

The fact that the door is locked in addition to being closed is detected by the detecting device of the locking condition.

The detecting device of the door closing condition thus provides a signal, which confirms that the door is closed. This signal transmits the fact that the door is closed and can thus be locked to a door locking control.

In turn, the detecting device of the door locking condition provides a signal, which confirms that the door is locked. This signal transmits the fact that the door can no longer be opened to the control electronics and that the household appliance can be actuated as a consequence.

### PRIOR ART

To date, the arrangement of a control which checks the closing condition of the door and allows to lock it, also detecting the locking condition of the door in order to prevent an actuation of the household appliance until such a locking condition of the door is detected, is the minimum requirement asked by household appliance safety standards.

Various solutions have thus been developed over the years to make devices which allow the mentioned dual function: to check closing with consequent possibility of actuating the lock and to check the correct locking condition.

As a representative example of the prior art reference is made to prior patent EP1834027, which describes a device based on a three-wire circuit as innovative. According to EP1834027, the invention it describes relates to a door locking device which comprises the function of checking the closing of the door and of locking it as mentioned above, and is based on a circuit which comprises only three connecting contacts, according to the diagram shown in appended FIG. 1, which reproduces FIG. 8 of patent EP1834027.

The same prior patent illustrates that the prior art, shown for example in FIG. 4, reproduced in FIG. 2 here, comprises examples of devices adapted to perform the same technical function described for the door lock which use no fewer than six connecting contacts to the control circuit of the household appliance.

The prior art shown in FIG. 3 (corresponding to FIG. 9 of patent EP1834027) relates instead to a known door locking device of the simpler type which thermoelectric actuators have three connecting contacts I, II and III, as shown in FIG. 3. Unlike the ones considered here, these door locks do not have any device for determining whether the household appliance door is closed or not. FIG. 3 diagrammatically shows an electric diagram for locking a door of known type with thermoelectric actuator, indicated as TA, in form of an actuator element indicated as PTC, and a device indicated as DV to detect a locking condition.

In order to obtain the locking of the door with electromagnetic actuator or thermomagnetic actuator, it was necessary to provide numerous connection devices on household appliance side, in particular three-contact connections on one side and six-contact connections on the other side, with this type of circuit.

The three-contact connection shown in FIG. 3 alone not being suitable to check the door closing condition and the door locking condition at the same time.

The technical solution which is the object of patent EP1834027, based on the circuit shown in FIG. 1 here, thus belongs to this prior art.

Such a solution includes the presence of a door contact switch 10, a locking contact switch 46 and an actuator 24, as electric switching diagram.

The door contact switch 10 and the actuator 24 are electrically connected in series between the connecting contact 20 and the second connecting contact 34.

In parallel to this switching in series, the locking contact switch 46 is connected between the first connecting contact 20 and the third connecting contact 56.

The door contact switch 10 is open until the door of the household appliance is closed.

Activation of the actuator 24 by supplying electric power through the first and the second connecting contacts 20 and 34 is therefore not possible.

The door contact switch 10 is closed if the household appliance door is closed.

Thus, the first and the second connections 30 and 32 of the actuator are electrically connected to the first and the second connecting contacts 20 and 34.

In this condition, the actuator 24 may by controlled by supplying energy by means of the first and the second connecting contacts 20 and 34, for example in form of pulse actuation.

The activation of the actuator 24 for locking the household appliance door causes a closing of the locking contact switch 46. This situation is indicated by a dashed line in the diagram in FIG. 1.

The closed locking contact switch 46 produces an electric connection between the first 20 and the third 56 connecting contacts in response to the locking.

An electric connection between the first and the third connecting contacts 20 and 56 confirms that the door is locked and that the household appliance may be started to the control electronics of the household appliance.

The first connecting contact 20 is generally connected to ground.

The second connecting contact 34 is generally connected with an electric connection to a household appliance control in order to be able to supply the control signals (e.g. pulse signals) to the actuator 34.

The first connecting contact 56 is preferably connected to a connection of a household appliance which has a predetermined potential, different from ground.

The current passes between the first and the second connecting contacts 20 and 56 if the locking contact switch 46 is closed. This passage of current confirms the locking condition of the household appliance.

### SUMMARY OF THE INVENTION

It is the main task of the present invention to provide a simplified door locking device, based on a circuit which includes a reduced number of connecting contacts to the machine.

In particular, it is mentioned that devices with from 6 to 5 contacts came to replace devices with 3 contacts in the sector over the years by virtue of the range of products introduced on the market also by the applicant itself during the 1970s and 1980s.

It is the object of the present invention to provide a configuration of an operating circuit for a door locking device of the type adapted to detect the closing condition and the locking condition of a household appliance door which is characterized in that it has only two connecting contacts to the machine electronics.

The present invention thus belongs to a prior art of currently known solutions which include at least the presence of three connecting contacts of the actuating circuit of the door locking device to the control electronics of the household appliance offering a technical solution which allows to reduce the connecting contacts of the device to the electronics of the household appliance to only two.

The advantages in terms of simplification of the device, and consequently of dimensions and production costs, are apparent.

It is sufficient to provide as reference indicator the fact that such door locking devices are required by the market for a total price lower than 1 Euro/piece to understand that any, however minor simplification of the same can be highly appreciated from the production and market point of view in a perspective of containing production costs, and reflects also in containing the wiring costs needed aboard the machine for connecting the device.

Furthermore, a device with only two contacts is more compact and thus less cumbersome in an assembly perspective of the household appliance.

This purpose and the other objects which will be more apparent following a detailed description of the present invention given here by means of illustrative, non-limitative example, are reached by a locking device of a household appliance door comprising a first and a second connecting contact with the household appliance, the device comprising:
a door closing switch, arranged on said first contact;
an actuator, arranged electrically in series with said door closing switch;
a door locking switch, arranged between said first connecting contact and second connecting contact, and arranged electrically in parallel to said actuator;
a diode, arranged between said first connecting contact and said second connecting contact, and arranged electrically in series with said locking switch;
an electric resistor, arranged on said second connecting contact.

### BRIEF DESCRIPTION OF THE FIGURES

Further features and advantages of the present invention will be more apparent in the following detailed description provided by way of non-limitative example and illustrated in the accompanying figures, in which:

figures from 1 to 3 show examples of door locking circuits of the known type of the prior art;

FIG. 4 shows an electric circuit of the locking device according to the present invention in an operating condition in which the door is open;

FIG. 5 shows the same diagram in FIG. 4 in an operating condition in which the door is closed but not locked;

FIG. 6 shows the same diagram in FIG. 5 in an operating condition in which the door is closed and locked.

### DETAILED DESCRIPTION OF THE INVENTION

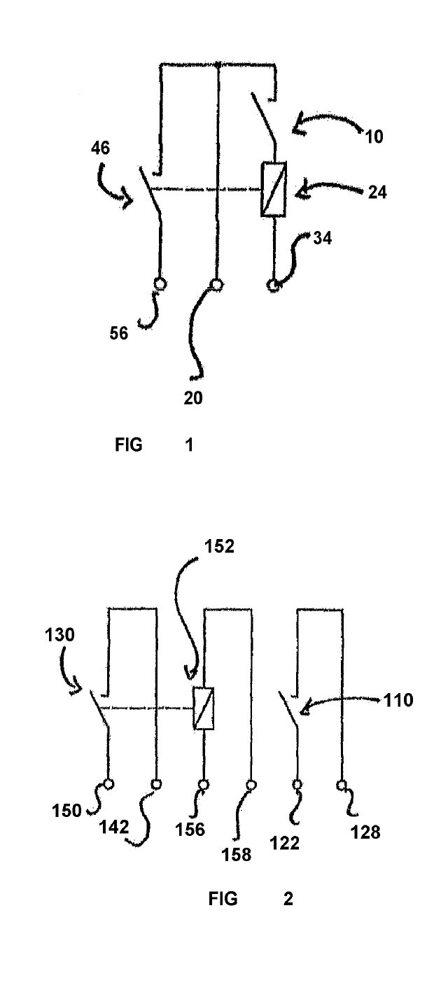

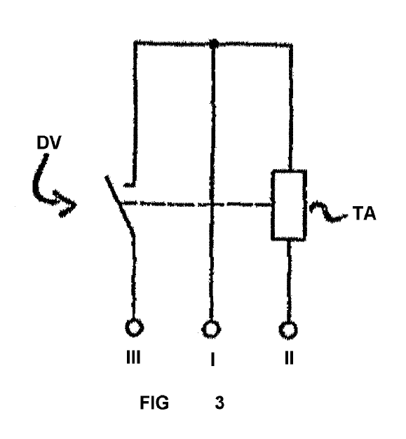

With particular reference to FIG. 4, the device 1 according to the present invention comprises only two connecting contacts to the household appliance, in particular a first contact 10 and a second contact 20.

Following the electric circuit diagram shown in FIG. 4 starting from said first connecting contact indicated by 10, the device 1 comprises a closing switch 30 of the door and an actuator 40, arranged electrically in series with said closing switch 30 on said first contact.

Continuing to follow the circuit starting from the first contact, it is therefore possible to identify a first branch 100 which has said closing switch 30 and said actuator 40 in series, and a second branch 200, electrically in parallel with said first branch 100, said second branch 200 comprising in turn a locking switch 50 of the door arranged electrically in series with a diode 70.

Said first branch 100 and said second branch 200 are thus arranged electrically in parallel between a first node 80 electrically connected to said first connecting contact 10 and a second node 90 electrically connected to said second connecting contact 20.

The device 1 according to the present invention further comprises an electric resistor 60 arranged between said second node 90 and said second connecting contact 20.

In the described general diagram, said actuator 40 may preferably consist of a solenoid valve, and in such a case the device will be supplied with alternating current.

With regards to the resistor 60, if the circuit includes a solenoid as actuator 40, said resistor may consist of a PTC, i.e. a ceramic element arranged to “protect” the solenoid, as known to a person skilled in the art.

The locking device described above operates as follows.

When the door of the household appliance is open, the circuit of the device 1 is in the configuration of FIG. 4, in which both switches, i.e. the door closing switch 30 and the door locking switch 50, are open.

In this configuration, the control electronics of the household appliance detects the open door condition deriving from the opening of the closing switch 30 at the terminals of the first 10 and of the second 20 connecting contact.

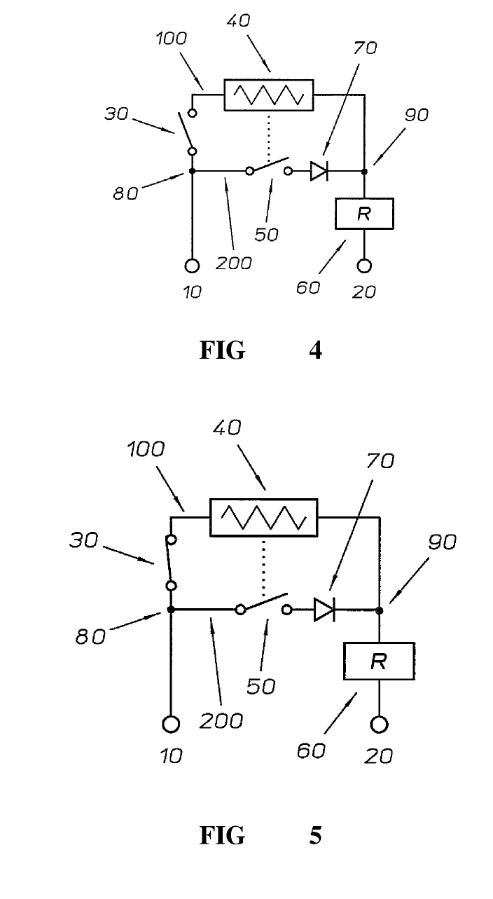

When the user manually closes the door of the household appliance, the closing switch 30 is closed and the control electronics thus detects an electric resistor given by the sum of the resistances determined by the presence of the actuator 40 and of the resistor 60, as shown in FIG. 5, between the first 10 and the second 20 connecting contact.

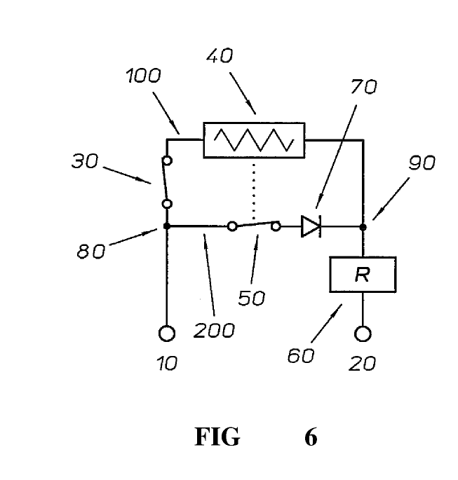

At this point, the control electronics sends an electric signal capable of actuating the actuator 40 which closes the locking switch 50, as shown in FIG. 6.

At this point, the control electronics of the household appliance detects a difference of potential, between the first 10 and the second connecting contact 20, associated to the presence of the actuator 40, of the diode 70 and of the resistor 60 and can thus check the door closing and locking condition.

In order to obtain the opening of the locking switch 50 at the end of the operating cycle of the household appliance, it is sufficient to provide a new pulse to the solenoid, being careful to send a signal (a half sinusoid signal, according to the orientation of the diode) that the diode 70 placed on said second branch 200 cannot block.

In this manner, the signal crosses the first branch 100 reaching the solenoid, which is thus actuated and determines the opening of the locking switch.

We have thus shown that the door locking device according to the present invention reaches the suggested purpose and objects.

In particular, we have shown that the door locking device according to the present invention allows to reduce the connecting contacts of the device itself to the household appliance to only two.

In addition to the apparent advantages in the overall dimensions of the device itself, this simpler, more compact configuration also provides considerable advantages in terms of cost-effectiveness deriving both from the lower production costs of the device itself and from the lower number of wires which need to be arranged in the household appliance.

Many changes may be made by a person skilled in the art without departing from the scope of protection of the present invention. The scope of protection of the claims, therefore, must not be limited to the illustration or preferred embodiments described by way of example, but rather the claims must include all the features of patentable novelty inferable from the present invention, including all the features that would be treated as equivalent by a person skilled in the art.

1. A locking device of a household appliance door, having a first and a second connecting contact to the household appliance, the device comprising:
a door closing switch, arranged on said first contact;
an actuator, arranged electrically in series with said door closing switch,
a door locking switch, arranged between said first connecting contact and second connecting contact, and arranged electrically in parallel to said actuator;
a diode, arranged between said first connecting contact and said second connecting contact, and arranged electrically in series with said locking switch;
an electric resistor, arranged on said second connecting contact.

2. A device according to claim 1, characterized in that said actuator is formed by a solenoid.

3. A device according to claim 2, characterized in that said resistor is formed by a PTC.
